(19) United States
(12) Patent Application Publication
(10) Pub. No.: US 2008/0138042 A1
(43) Pub. Date: Jun. 12, 2008

(54) Method for providing preventive maintenance

(76) Inventor: Frank John Williams, Los Alamitos, CA (US)

Correspondence Address: Frank John Williams, 2711 Saint Albans Dr., Los Alamitos, CA, 90720, US

(21) Appl. No.: 11/497,054

(22) Filed: Aug. 1, 2006

Related U.S. Application Data
(60) Provisional application No. 60/704,815, filed on Aug. 1, 2005.
(60) Provisional application No. 60/764,931, filed on Feb. 3, 2006.
(60) Provisional application No. 60/780,473, filed on Mar. 8, 2006.

(51) Int. Cl. H04N 7/26

(52) U.S. Cl. 386/124

(57) ABSTRACT

A method and system for providing preventive maintenance information implementing at least one preventive maintenance form and/or protocol. Wherein, the provided information involves the implementation of at least one motion picture demonstrating at least one of the said preventive maintenance procedures of an apparatus.

### RELATED APPLICATIONS

This application claims the benefit of: provisional patent application Ser. No. 60/704,815, filed 2005 Aug. 1, provisional patent application Ser. No. 60/764,931 filed 2006 Feb. 3, and provisional patent application 60/780,473 filed 2006 Mar. 8, by the present inventor

### BACKGROUND

1. Field of the Present Disclosure

This disclosure relates to several methods for providing information. More specifically, a method for providing preventive maintenance information to technicians and end-users alike.

2. Description of Related Art

Today's offices and homes are inhabited with a series of apparatuses that make modern life possible. However, equipment failure is always a possibility threatening to hold production with no warnings what so ever. The answer to these shortcomings is preventive maintenance. Preventive maintenance saves the client and their apparatuses from annoying and damaging malfunctions. Unfortunately, today's high sophisticated machines make many of these preventive maintenance procedures complex and extensive. Furthermore, manuals make these preventive procedures even more difficult to follow due to their lacking capabilities to instruct its content in a graphic and simple manner. Another inconvenience of printed material is that encountered by updates. Once a document is printed, is impossible to modify it is re-written again and that is simply too expensive. For the most part, such updates take the shape of an individual separate document also known as a “technical publication” produced to overrule or modify the data in the manual. Such documents are easy to loose, misplace or simply ignore. In addition to all these, preventive maintenance schedules are difficult and elaborate to follow and allows for possible over viewing of safety procedures.

In view of the foregoing and shortcomings, the disclosed inventive methods teaches away from the commonly used methodologies, while solving felt needs and provides unappreciated advantages distinguishing it over the prior art by also providing heretofore additional unknown advantages as described in the following summary.

### SUMMARY

It is therefore the object of the present invention to teach a method for providing preventive maintenance information to clients in a quick, objective, affordable and fashionable manner. This disclosure teaches certain benefits in construction and use which give rise to the objectives described below.

A primary objective inherent in the above described method of use is to provide advantages not taught by the prior art;

Another objective is to save money to client by avoiding possible equipment breakdowns;

Another objective is to void possible situation including client anxiety and frustration;

Another objective is to reduce the number of field technical visits;

Another objective is to extend equipment's life time;

Another objective is to increase equipment performance;

Another objective is to standardize the quality of preventive servicing information;

Another objective is to standardize the quantity of preventive servicing information;

Another objective is introduce the client to their apparatus, thus avoiding future equipment misusage;

Another objective is to permit to recognize equipment exhaustion due to frequency and/or deepness of problems;

A further objective is to provide preventive maintenance information around the clock;

Another objective is to allow the immediate modification of the particular procedures permitting instantaneous updates;

A further objective is to eliminate the possibility of identifying and/or ordering incorrect parts which are not related to the relevant preventive maintenance procedure;

A further objective is to establishes fervent relations with the end-user, especially on home-office environments, wherein person to person communications, service response time and budgets are always of an essence;

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present method of use. In such drawings:

FIG. 1 shows a block diagram of the general steps of the inventive method;

FIG. 2 is an illustration of an exemplary Preventive Maintenance Protocol, specifically a form;

### DETAILED DESCRIPTION OF THE PREFERRED EMBODIMENT

The above described drawing figures illustrate the described methods and use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

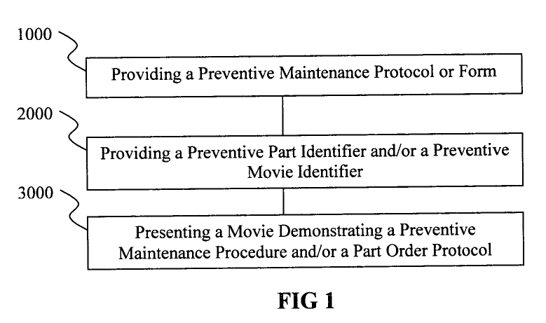

FIG. 1 illustrates a block diagram of the general steps of the inventive method. The first step of the method is to provide a Preventive Maintenance Protocol and/or Form 1000 (FIG. 1). Noteworthy, the Preventive Maintenance Protocol and/or Form (PM-PF) can be produced by a machine(s) and/or system(s). For example, a non-limiting case is that involving an Internet site. Such a site is visited by the client who ultimately views and/or accesses a PM-PF. Another sample will be that of a handheld service aid device; in which the technician proceeds to enable a PM-PF of a given apparatus in order to view and follow the respective preventive maintenance procedures.

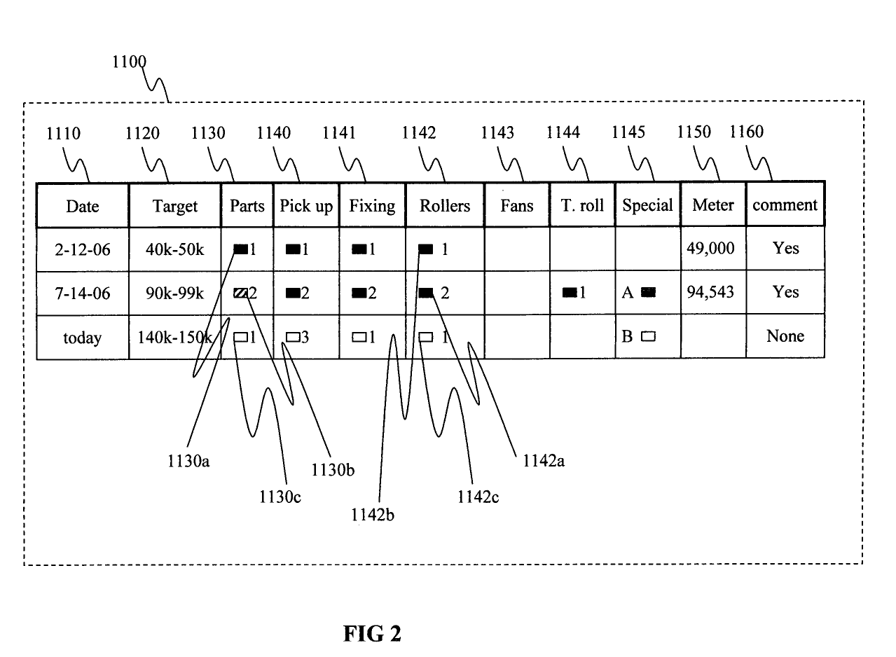

The second step is for the PM-FP to provide the client at least one information identifying a possible movie 2000 (FIG. 1) which demonstrates the preventive maintenance procedure. Another optional yet important issue is for the PM-FP 2000 (FIG. 1) to include at least one part identifier used to identify at least one part involved in the preventive maintenance procedure and/or at least one part present in a upcoming preventive maintenance procedure. FIG. 2 illustrates a non-limiting sample of a PM-PF 1100 (FIG. 2). In this sample, the PM-PF 1100 (FIG. 2) contains a series of information in the form of columns. These series of data includes the following: Date 1110 (FIG. 2) containing the particular date in which the preventive maintenance was executed, Target 1120 (FIG. 2) containing information displaying the meter or volume of prints when the preventive maintenance is due for the printer, Parts 1130 (FIG. 2) providing information as to which parts are involved, Fixing 1141 (FIG. 2) providing information demonstrating the preventive maintenance procedure for the fixing unit, Rollers 1142 (FIG. 2) providing information demonstrating the preventive maintenance procedure for the rollers, Filters 1143 (FIG. 2) providing the preventive maintenance information of the fans and filters, Transfer roller 1144 (FIG. 2) providing information demonstrating the preventive maintenance procedures of the transfer roller and transferring assembly, Special 1145 (FIG. 2) providing informing of extraordinary events such as uncommon maintenance procedures and/or important updates, Meter 1150 (FIG. 2) containing the information of the meter entered by the client upon completing or abandonment of the preventive maintenance procedures, and finally Comments 1160 (FIG. 2) containing data the client considered important to remember or mention, and/or data that the technical support department considers relevant to post. Noteworthy is the first and last two identifier which are the Date 1110 (FIG. 2), Meter 1150 (FIG. 2) and Comments 1160 (FIG. 2); each of them reflecting specific client information, thus implying that the client must identify himself in order to match such data with the PM-PF viewed by the client. While this is a preferred method, it doesn't limit the ability of the PM-PF to procure a general intent or purpose; since a PM-PF without such optional information can still provide valuable information to a single client to follow the demonstrating movies of different maintenance procedures. Returning our attention back to FIG. 2 it can be appreciated that other important information and optional information is also being displayed. In the Rollers 1142 (FIG. 2) column for example, the form depicts three roller identifiers 1142a (FIG. 2), 1142b (FIG. 2) and 1142c (FIG. 2) respectively, of which they all identify a respective movie demonstrating a particular preventive maintenance procedure for all the pick and feed rollers in the printer. Taking a closer look it can be noticed that there are still other slightly differences such as the number in the movie identifier or link. While the first identifier 1142a (FIG. 2) has a number 1, the second movie identifier 1142b (FIG. 2) has a number 2. Both of these numbers are used to indicate differences between the content of each movie. In other words, while both movies demonstrate issues about the rollers, the content of the first movie 1142a (FIG. 2) is different to that of the second movie 1142b (FIG. 2). Another sample of such a category can be appreciated between the first movie identifier 1142a (FIG. 2) and the third movie identifier 1142c (FIG. 2) in the same column. Since the first movie identifier 1142a (FIG. 2) contains a number 1, and the third movie identifier 1142c (FIG. 2) also contains a number 1; this therefore indicates that their movie content is identical. In this manner, a viewing client can quickly identify if he/she is familiar with the movie. For example, in the case that the client is not sure or doesn't have a good recollection of the events demonstrated in the movie, all that is needed is to simply click on the link to view the movie once again. Another important and optional issue depicted between the first movie identifier 1142a (FIG. 2) and the third movie identifier 1142c (FIG. 2) is fact their colors. The first identifier 1142a (FIG. 2) is solid black, while the third identifier 1142c (FIG. 2) is white. In this sample a chromatic category (color) is used the indicated accomplishment or finalization of the procedure. In other words, the color black means that the movie was seen and all content was imitated and/or fulfilled, while the color white indicates that the movie has not even being seen yet. Another non-limiting and additional sample is that present in the Parts 1130 (FIG. 2) column identifiers, wherein the first part identifier 1130a (FIG. 2) and the second part identifier 1130b (FIG. 2) display two differences. The first difference is that of the number, which as just recently explained indicates that the content of the files is different (in this case of parts the difference is in the parts used or parts' list). The other difference is in the color which as recently explained is used to indicate the accomplishment. The solid color of the first identifier 1130a (FIG. 2) indicates that all parts were replace, while the color of the second identifier 1130b (FIG. 2) indicates that only some parts were replaced, thus signifying an incomplete parts replacement (parts are still due, backorder, etc).

Another important and non-limiting element of the inventive method is that of data manipulation and/or storage. For example, in a particular instant, the PM-FP in a document or file containing the movie links. In another instant, the PM-FP is the result of a database form, in which the different movie and/or part identifiers are generated by databases and their respective queries.

Another sample, but worth mentioning is what happens when an identifier is clicked. In the most basic sample, a movie is simply played and that is all. The client can simply click the back key (or other) and return to the PM-PF 1100 (FIG. 2). A more evolved sample and system is that in which the movie is played with an accompanying protocol.

The next and final step of the inventive method is the obvious step of ultimately displaying a movie 3000 (FIG. 1) to client demonstrating the particulars of the selected preventive maintenance procedure(s). Although this step appears to be simple, many possible combinations complicate the possibilities of “delivery” of such a movie and its content. E-mails could be sent latter, the movie identifiers are used to indicate the client where and/or how to obtain the movie, etc, etc. But these alternative delivering method(s) do not departure from the basic spirit of the inventive method, and that is to provide preventive maintenance protocol and/or form including at least one movie (graphic motion display in general terms) demonstrating the preventive maintenance procedure of a given apparatus.

Notable, is the meaning of a preventive maintenance procedure; for which in this disclosure implies at least one of a: immediate preventive maintenance procedure, and an alternative preventive maintenance procedure, wherein each of then respectively implies the following:
a) Immediate Preventive Maintenance Procedure: at least one precautionary unit action or set of precautionary unit actions, including: controlling at least one feature of the apparatus, controlling at least one process of the apparatus, controlling at least one element of the apparatus, upgrading at least one feature of the apparatus, upgrading at least one element of the apparatus, upgrading at least one process of the apparatus, suggesting at least one element of the apparatus, suggesting at least on process of the apparatus, commenting at least one element of the apparatus, commenting at least one process of the apparatus, manipulating at least one process of the apparatus, manipulating at least one element of the apparatus, correcting at least one element of the apparatus, correcting at least one process of the apparatus, replacing at least one element of the apparatus, identifying at least one element of the apparatus, identifying at least one process of the apparatus, removing at least one element of the apparatus, installing at least one element in the apparatus, installing at least one process in the apparatus, deleting at least one process of the apparatus, setting up at least one accessory of the apparatus, diagnosing at least one element of the apparatus, diagnosing at least one process of the apparatus, connecting at least one element of the apparatus, and assembling at least one plurality of elements of the apparatus.
b) Alternative Preventive maintenance procedure: at least one alternative precautionary unit action or set of alternative precautionary unit actions, including: controlling at least one feature of the apparatus, controlling at least one process of the apparatus, controlling at least one element of the apparatus, upgrading at least one feature of the apparatus, upgrading at least one element of the apparatus, upgrading at least one process of the apparatus, suggesting at least one element of the apparatus, suggesting at least on process of the apparatus, commenting at least one element of the apparatus, commenting at least one process of the apparatus, manipulating at least one process of the apparatus, manipulating at least one element of the apparatus, correcting at least one element of the apparatus, correcting at least one process of the apparatus, replacing at least one element of the apparatus, identifying at least one element of the apparatus, identifying at least one process of the apparatus, removing at least one element of the apparatus, installing at least one element in the apparatus, installing at least one process in the apparatus, deleting at least one process of the apparatus, setting up at least one accessory of the apparatus, diagnosing at least one element of the apparatus, diagnosing at least one process of the apparatus, connecting at least one element of the apparatus, and assembling at least one plurality of elements of the apparatus

The enablements described in detail above are considered novel over the prior art of record and are considered critical to the operation of at least one aspect of the method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a novel method for providing preventive maintenance information can be appreciated. The described method overcomes the impediments faced by manuals and other currently used documents for disseminating preventive maintenance information. Furthermore, the method and system(s) promotes superior equipment performance and relating parts identification and distribution.

1. A method for a person for providing technical support to a client, comprising the steps of:
1. Communicating with the client, including at least one of a: end-user, technician, third party person, apparatus, field service apparatus, third party apparatus, and system;
2. Selecting a motion picture demonstrating a servicing procedure;
3. Identifying an Internet Site;
4. Implementing the Internet Site for providing the client an information identifying the selected motion picture;
Whereby client can perform at least one obtaining action including: obtaining information on said motion picture, obtaining information in said motion picture, viewing said motion picture, identifying said motion picture, and downloading said motion picture.
